(19) United States
(12) Patent Application Publication
(10) Pub. No.: US 2023/0404188 A1
(43) Pub. Date: Dec. 21, 2023

(54) SURGICAL MASK HAVING SLIDING-DOWN AND FOGGING PREVENTING FUNCTION

(71) Applicant: Kang Kweon KIM, Goyang-si, Gyeonggi-do (KR)

(72) Inventor: Kang Kweon KIM, Goyang-si, Gyeonggi-do (KR)

(21) Appl. No.: 18/035,305

(22) PCT Filed: Nov. 2, 2021
(86) PCT No.: PCT/KR2021/015693

§ 371 Date: May 4, 2023

(30) Foreign Application Priority Data
Dec. 8, 2020 (KR) 10-2020-0170559
Jan. 8, 2021 (KR) 10-2021-0002262

(51) Int. Cl. A41D 13/11

(52) U.S. Cl. CPC A41D 13/1115; A41D 13/1161; A41D 2600/20; A41D 2400/00

(57) ABSTRACT

The present disclosure provides a dental mask having an anti-flow and fogging function which has a nose ridge contact cover attached to the upper portion of the inside of a mask body, thereby being maintained at a normal wearing state without moving out of the ridge of the nose because it does not slip down even if a user talks or yawns with the mask on, thereby preventing glasses from being fogged by exhalation, and thereby keeping both sides of the mask body in close contact with the cheeks of the wearer without coming off from the cheeks.

### FIELD OF THE INVENTION

The present disclosure relates to a dental mask and, more particularly, to a dental mask having an anti-flow and fogging function, the dental mask not moving out of the ridge of the nose because it does not slip down even if a user talks with the mask on, preventing glasses from be fogged, and preventing leakage because both sides of the mask body is kept in close contact with the cheeks.

### BACKGROUND OF THE INVENTION

In general, a mask is a product that covers the nose and mouth to block external cold air, prevent inhalation of bacteria, dust, etc., and block splashes. Various types of masks are sold in accordance with the use including a winter mask made of fabric, etc., an industrial mask having a combination of various filters to be able to block even fine dust, and a dustproof mask. As World Health Organization (WHO) has recently proclaimed global Pandemic due to corona virus infection (COVID-19) after SARS and MERS, the interest in masks has increased and wearing a mask has become daily work, so a mask has become a necessary item when people go out.

A mask can show the effect thereof when it is normally worn to cover the nose and the mouth, but it is difficult to breathe when the nose and the mouth are both covered. Accordingly, some people wear a mask without the nose covered or wear a mask on the chin without both of the nose and mouth being covered. In particular, recently, Korean government has enforced an administrative measure of making it duty to wear a mask when going out due to re-spread of COVID-19, but quarrels frequently occur because of people who do not wear a mask in publicly used facilities, public transportation, or public places. However, the problem that most people experience when wearing a mask is that even though they normally wear a mask, the mask slips down and moves out of the ridge of the nose and does not cover the nose during conversation, so the users have to repeat covering the nose with the mask by holding and pulling up the mask body by hand. Further, there is another severe problem that since they hold and pull up the mask body by hand, the virus sticks to the hand, which is a reason of infection.

Further, the most inconvenient thing that the people who wear glasses feel when wearing a mask is that the glasses are fogged by exhalation (the steam of breath) and the view is obstructed even though they do not have a conversation with a mask on, so they are very inconvenienced. Further, there is a problem that they have to frequently take off the glasses to look at the front.

In order to solve this problem, a “mask that is easily worn and prevented from slipping down”, a “mask with a tightener”, etc. have been disclosed in Korean Patent Nos. 1418787, 1651728, etc., respectively, but the mask bands are configured to surround the head in the disclosures, so this configuration is difficult to apply to a disposable mask worn only once.

Meanwhile, the 3D mask of sanitary masks has a nose ridge contact cover, which is placed on the ridge of the nose and supports the mask to prevent slipping-down, on the top of a dome-shaped mask body and a chin cover that supports the chin, in which the nose ridge contact cover and the chin cover are separately provided. Further, a 2D mask has a structure in which a central upper end of a mask shape is held on the ridge of the nose, so the masks relatively slip down little even though users have a conversation with the masks on.

However, as for dental masks or surgical masks, since the mask body has a rectangular shape and a nose wire is embedded in the upper end of the mask body, there is a problem that when a user talks with the mask on, the face moves, so the mask unavoidably slips down. Further, the mask body cannot block the gaps formed by the curved portions at both sides of the ridge of the nose due to the structural problem of the mask body, so there is a problem that glasses are severely fogged due to exhalation (the steam of breath). Further, both sides of the mask body having a rectangular shape come off from the cheeks of the wearer without being in close contact with the cheeks when the mask is worn, so there is a severe problem that leakage occurs or various viruses or dust enter through the gaps.

### DETAILED DESCRIPTION OF THE INVENTION

### Technical Problem

The present disclosure has been made in an effort to solve the problems described above and an objective of the present disclosure is to provide a dental mask having an anti-flow and fogging function which has a nose ridge contact cover attached to the upper portion of the inside of a mask body, thereby being maintained at a normal wearing state without moving out of the ridge of the nose because it does not slip down even if a user talks or yawns with the mask on, thereby preventing glasses from being fogged by exhalation, and thereby keeping both sides of the mask body in close contact with the cheeks of the wearer without coming off from the cheeks.

### Means of Solvong the Problem

The dental mask according to the present disclosure is that since a nose ridge contact cover is disposed at the upper end on the inner surface of the dental mask, the nose ridge contact cover comes in close contact with the ridge of a nose when the mask is worn, whereby the mask does not slip down when the user talks, glasses are prevented from being fogged by completely blocking gaps around the ridge of the nose when a user wears the mask, and both sides of the mask body come in close contact with the cheeks of a wearer.

### Effects of the Invention

Since the dental mask of the present disclosure has a structure in which the upper end and both sides of the nose ridge contact cover having a uniform width are bonded to the upper end of the inner surface of the mask body formed in a rectangular shape, the center portion of the lower end of the nose ridge contact cover which is not bonded to the mask body is held in close contact with the ridge of a nose when the mask is worn. Accordingly, even if a wearer talks or yawns with the mask on, the mask does not move out of the ridge of a nose, so the mask can be maintained in the normally worn state without slipping down. Further, since the nose ridge contact cover blocks gaps while being in close contact with the ridge of a nose and the curved portions at both sides of the ridge of the nose, it is possible not only to prevent viruses from entering through the gaps, but to prevent glasses from being fogged by exhalation.

Further, when the mask is put on and the ear bands are hung on ears, the upper end and the lower end of the sides of the rectangular mask body are pulled outward by the ear bands. Further, the height of the nose ridge contact cover increases with the center of the lower end of the nose ridge contact cover in close contact the ridge of a nose, and both sides of the mask body are pulled inward. Accordingly, both sides of the mask body come in close contact with the cheeks of the wearer without coming off. Therefore, it is possible to completely solve the problem that when a common dental mask without a nose ridge contact cover is worn, both sides of the mask body come off from the cheeks of the wearer, whereby leakage occurs or various viruses or dust enter.

### BRIEF DESCRIPTION OF THE DRAWINGS

FIG. 1 is a view showing the outer surface of a dental mask according to the present disclosure;

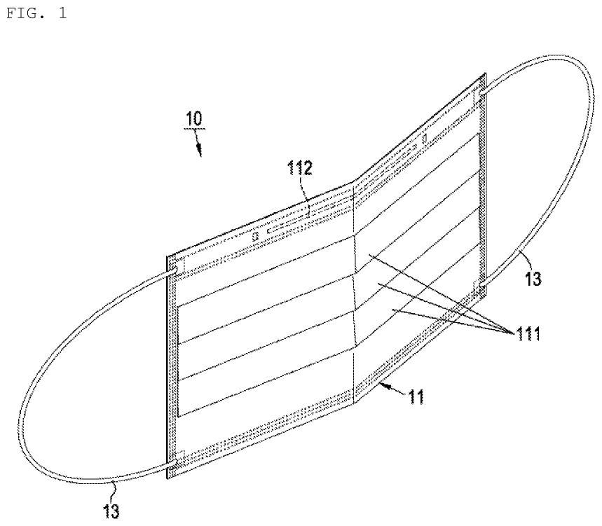

FIG. 2 is a view showing an embodiment in which all of the sides of a nose ridge contact cover attached to the inner surface of a mask body have been bonded.

FIGS. 3A and 3B are views showing embodiments in which both sides of the nose ridge contact cover have been partially bonded and part of the lower end have not been bonded.

FIG. 4 is a view showing the state in which the nose ridge contact cover has been separated from the mask body; and

FIG. 5 is a view showing the state when the dental mask according to the present disclosure is worn.

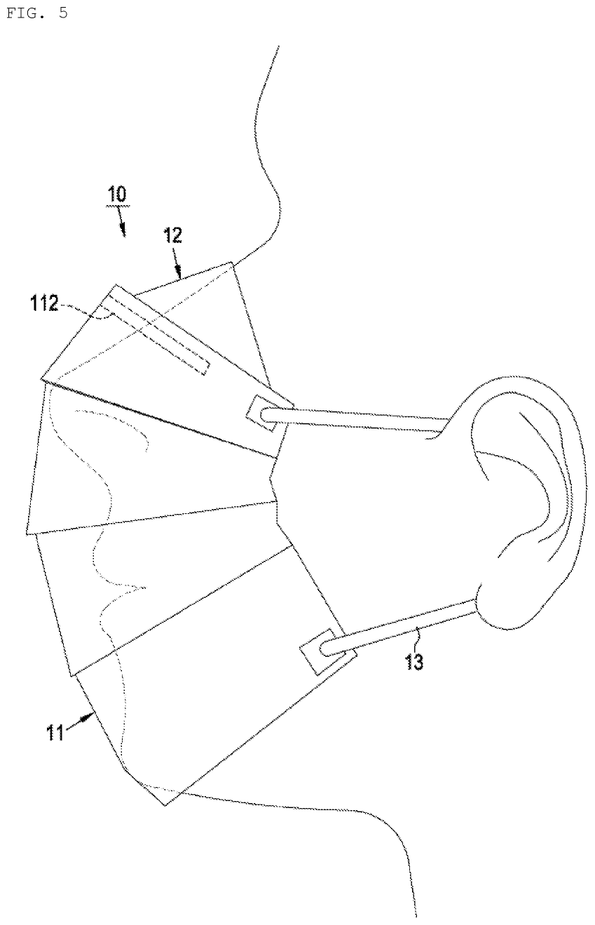

### REFERENCE NUMBERS

10 dental mask
11: mask body
111: wrinkled portion
112: nose wire
12: the nose ridge contact cover
121: bonded portion
122: non-bonded portion
13: ear band

### DESCRIPTION OF THE MOST PREFERRED EMBODIMENTS

A dental mask having an anti-flow and fogging function according to the present disclosure is composed of: a rectangular mask body configured to cover the mouth and nose of a wearer and having a nose wire embedded in the upper end thereof; and ear bands attached to both sides of the mask body, respectively, to prevent the mask body from separating from a face when the mask is worn. The dental mask includes a nose ridge contact cover of which the upper end and both sides are bonded to the upper portion of the inner surface of the mask body, the upper end of the nose ridge contact cover is positioned below the portion where the nose wire is embedded in the mask body, and the lower portion of the nose ridge contact cover is separated from the mask body such that the nose ridge contact cover is held in close contact with the ridge of the nose of the wearer when the mask is worn.

Preferably, the upper end of both sides of the nose ridge contact cover is a bonded portion bonded to the mask body, and the lower portion of the bonded portion at both sides is a non-bonded portion separated from the mask body.

Preferably, the top-bottom height of the nose ridge contact cover is ½ to ⅓ of the top-bottom height of the mask body.

### DETAILED DESCRIPTION OF THE PREFERRED EMBODIMENTS

A mask having a nose ridge contact cover 12 attached thereto according to the present disclosure is applied to dental masks having a rectangular mask body 11 and surgical masks that are generally used by medical personnel such as doctors and nurses, and is not applied to 3D masks separately having a nose ridge contact cover, which is held on the ridge of a nose, at the upper portion of a mask body and a chin cover at the lower portion and 2D masks of which the mask body is folded such that the upper end of the folded portion is naturally held on the ridge of a nose. Accordingly, it should be noted that the term ‘dental mask’ used therein includes not only a dental mask, but a surgical mask.

A dental mask 10 has a rectangular mask body 11 for covering the mouth and nose of a wearer and ear bands 13 attached to both side of the mask body 11, respectively, to prevent the mask body from separating from the face of the wearer when the wearer wears the mask, in which a nose wire 112 that is folded to fit to the shape of the ridge of a nose when the mask is worn is embedded in the center portion of the upper end of the rectangular mask body 11, the edges of the rectangular shape are bonded, and the mask body 11 has a wrinkled portion 111 having a two-step or three-step wrinkled structure such that the folded portion is unfolded and the area increases to fit to the shape of the face of the wearer when the mask is worn, which is the general structure of a dental mask.

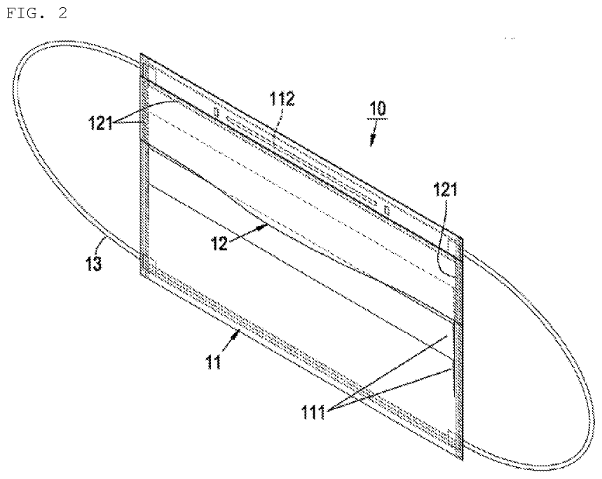

The most characteristic part of the dental mask 10 according to the present disclosure is the nose ridge contact cover 12. The nose ridge contact cover 12 is positioned at the upper end of the inner surface of the mask body 11 with both sides and the upper end bonded to the mask body 11 (see FIG. 2). ‘Bonding’ is to couple two parts, so sewing is also included in the meaning of the term ‘bonding’.

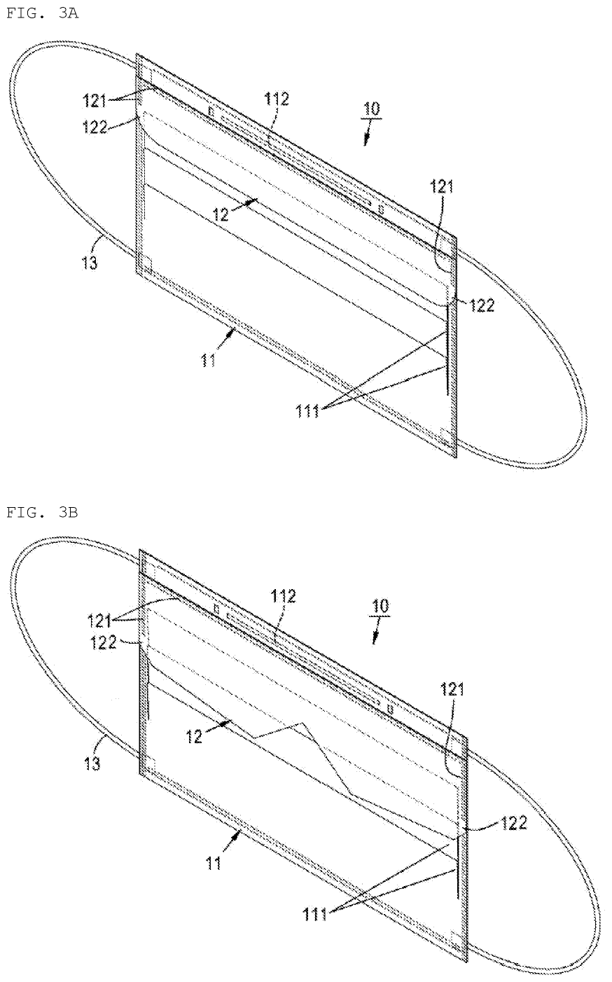

The nose ridge contact cover 12 has a quadrilateral shape such as a rectangle or a trapezoid having a uniform width (the ‘width’ means the top-bottom height), but is not limited to the quadrilateral shape and may have various shapes such as a quadrilateral shape with the lower ends of both sides chamfered or rounded like an arc. The lower portion of the nose ridge contact cover 12 may also be rounded. The nose ridge contact cover 12 may be formed in various shapes, for example, by vertically cutting the center of the lower portion by a predetermined length or triangularly cutting the lower portion (see FIGS. 3A and 3B). When the center of the lower portion of the nose ridge contact cover 12 is cut by a predetermined length or triangularly cut, the cut portion or the triangle shape is held on the ridge of a nose, so the nose ridge contact cover 12 comes in further close contact with the curved portions around the ridge of a nose, thereby being able to increase the effect of preventing fogging and leaking.

The nose wire 112 is bent into the shape of the ridge of a nose to maintain the shape of the mask body when the mask is worn. However, according to the present disclosure, since the nose ridge contact cover 12 is held on the ridge of the nose in close contact with the ridge of the nose, so the there is no specific function that the nose wire 112 can provide, so the nose wire is not a necessary part. A nose wire may be used for the wrong purpose as an offensive weapon by prisoners in correctional institutions. However, the dental mask according to the present disclosure does not necessarily need a nose wire and is economically superior to a 2D mask and a 3D mask in terms of structure, so the dental mask is an optimal mask to be used in correctional institutions.

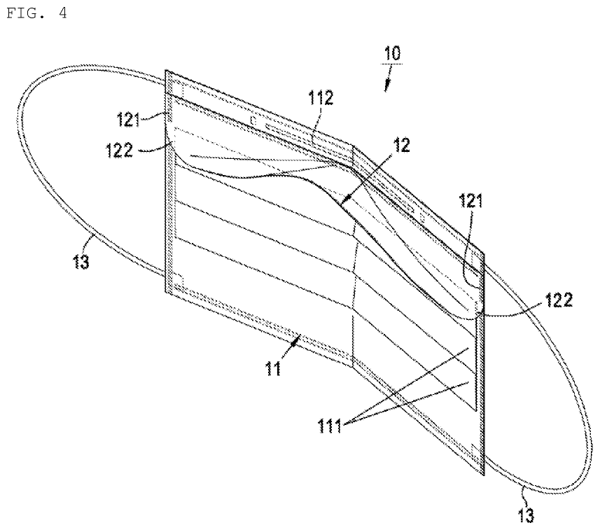

In the shape of the noise ridge contact cover 12, since the lower portion is separated from the mask body 11 without being bonded, when the nose wire 112 is folded to fit to the shape of the ridge of a nose and the lower portion of the nose ridge contact cover 12 is separated from the mask body 11 with the mask on, a space is formed between the nose ridge contact cover 12 and the inner surface of the mask body 11. Accordingly, it is possible to wear the dental mask 10 with the nose ridge contact cover 12 at the portion where the space is formed on the ridge of a nose (see FIG. 4).

It is preferable that the upper end of the nose ridge contact cover 12 is positioned below the portion where the nose wire 112 is embedded in the mask body 11 when the upper end of the nose ridge contact cover 12 is bonded to the mask body 11. Since the nose ridge contact cover 12 is positioned below the portion where the nose wire 112 is embedded in the mask body 11, the nose ridge contact cover 12 can come in close contact with the ridge of a nose without being interfered by the nose wire 112. Further, since both sides of the nose ridge contact cover 12 are bonded to the mask body 11, the nose ridge contact cover 12 is held at both sides not to slip down. Further, since the upper end of the nose ridge contact cover 12 is bonded below the nose wire 112, even though a wearer holds and pulls down the mask body 11 by hand, only the mask body 11 is slightly moved down and the nose ridge contact cover 12 is kept in close contact with the ridge of a nose.

If the nose ridge contact cover 12 is bonded over the portion where the nose wire 112 is embedded in the mask body 11, not only the contact force that brings the nose ridge contact cover 12 in close contact with the ridge of a nose decreases, but the nose wire 112 cannot come in contact with the ridge of the nose when the mask is worn. Further, the wrinkled portion 111 is not fully flattened and the nose ridge contact cover 12 protrudes from the upper portion of the mask body 11, which is not good for the external appearance. Further, the protruding portion may interfere with the view, so it is inconvenient to wear the mask.

Since a nose wire is not embedded in the nose ridge contact cover 12, the nose ridge contact cover 12 can be flexibly brought in close contact with the ridge of a nose. Accordingly, the gaps at the curved portions at both sides of the ridge of a nose are completely blocked, whereby viruses are prevented from entering through the gaps. Further, it is possible to prevent glasses from being fogged due to exhalation from a wearer talking with mask on or breathing. Further, since both sides of the nose ridge contact cover 12 are bonded to the mask body 11, when the mask is put on and the ear bands 13 are hung on ears, the upper end and the lower end of the sides of the rectangular mask body 11 are pulled in the side direction by the ear bands 13. Further, the mask body 11 is pulled inward due to the bonded portions at both sides of the nose ridge contact cover 12 while the height of the nose ridge contact cover is increased as the center of the power end is held on the ridge of a nose. Accordingly, the nose ridge contact cover 12 does not slip down and both sides of the mask body 11 come in close contact with the cheeks of the wearer without coming off. Therefore, the problem that both sides of the mask body come off from the cheeks of the wearer when a user wears a common dental mask is completely solved.

However, according to 3D masks, a nose ridge contact cover is disposed as a separate part on the upper portion of a dome-shaped mask body and a nose wire is embedded in the nose ridge contact cover. Accordingly, when the mask is put on with the nose wire folded to fit to the shape of the ridge of a nose, the mask blocks the gaps at the curved portions at both sides of the ridge of the nose in the early stage, but even after a short time, the nose wire is unfolded due to elasticity, whereby the mask cannot block the gaps at the curved portions at both sides of the ridge of the nose. Therefore, there is a problem that it is impossible to prevent not only entrance of viruses through the gaps, but fogging. Similarly, for 2D masks, since a nose wire is embedded in the upper end of the mask body, the same problem as that of the 3D mask is generated. However, since a nose wire is not embedded in the nose ridge contact cover 12 according to the present disclosure and the nose ridge contact cover 12 is flexible, the nose ridge contact cover 12 comes in close contact with the ridge of a nose regardless of the size of the wearer's face or nose. Accordingly, it is possible to completely solve the problem that is generated in 2D masks and 3D masks.

FIG. 2 shows an embodiment in which both sides of the nose ridge contact cover 12 are entirely bonded to the mask body 11. However, as shown in FIGS. 3A and 3B, both sides of the nose ridge contact cover 12 may be not entirely, but partially bonded. In detail, the upper portion of both sides of the nose ridge contact cover 12 is a bonded portion 121 bonded to the mask body, and the portion below the bonded portion 121 of both sides is a non-bonded portion 122 not bonded to the mask body 11.

When the mask is worn and the nose ridge contact cover 12 is separated from the mask body 11, the nose ridge contact cover 12 and the non-bonded portions 122 at the lower portion and both sides of the nose ridge contact cover 12 where the mask body 11 are not bonded are separated from the mask body 11 and a space is formed between the nose ridge contact cover 12 and the inner surface of the mask body 11. Accordingly, the mask is worn with the nose ridge contact cover 12 on the ridge of the wearer's nose at the portion where the space is formed such that the nose ridge contact cover 12 is held in close contact with the ridge of the nose.

Since the non-bonded portions 122 that are not bonded to the mask body 11 are formed at the lower ends of both sides of the nose ridge contact cover 12, people who have a large nose can wear the mask without a problem. It is also possible to easily wear the mask with the nose ridge contact cover 12 on the ridge of a nose regardless of the size of the face or the nose. Both sides of the mask body 11 can come in close contact with the wearer's cheeks while forming natural lines without being wrinkled.

It is preferable that the top-bottom height of the nose ridge contact cover 12 is about ½ to ⅓ of the top-bottom height of the mask body 11. If the top-bottom height of the nose ridge contact cover 12 is larger than ½ of the top-bottom height of the mask body 11, not only it is difficult and inconvenient to wear the mask, but the sides of the mask body 11 are wrinkled when the mask is worn. If the top-bottom height is small to be ⅓ or less, the portion of the nose ridge contact cover 12 that is held on the ridge of a nose is small, so the nose ridge contact cover 12 cannot be stably held on the ridge of a nose. Even if the nose ridge contact cover 12 is held on the ridge of a nose, the nose ridge contact cover 12 slides, so the possibility of the mask body 11 moves out of the ridge of a nose increases.

The nose ridge contact cover 12 may be separately attached after the mask body 11 is fabricated. However, it is preferable that the nose ridge contact cover 12 is composed of two layers by folding a predetermined portion of the mask body 11 in the same way as the method of forming the wrinkled portion 111 by folding a predetermined portion of the mask body 11 when the mask is fabricated in order to increase convenience for fabrication and reduce the manufacturing cost. The two-layered structure increases the contact force that brings the nose ridge contact cover 12 in close contact with the ridge of a nose, and increases the force holding the mask body 11 to prevent the mask body 11 from moving out of the ridge of a nose. Further, the function of preventing fogging by blocking the gaps at the curved portions around the ridge of a nose can be improved, and the mask can be simply fabricated.

The above description is provided as an example of the present disclosure and the embodiments described herein are provided to describe the present disclosure rather than limiting the spirit of the present disclosure, so the present disclosure may be changed and modified in various ways by those skilled in the art without departing from the scope of the present disclosure. Therefore, the protective range of the present disclosure should be construed by those described in claims and technical configuration in the equivalent range should also be construed as being included in the scope of the present disclosure.

### INDUSTRIAL APPLICABILITY

The dental mask according to the present disclosure is that since a nose ridge contact cover is disposed at the upper end on the inner surface of the dental mask, the nose ridge contact cover comes in close contact with the ridge of a nose when the mask is worn, whereby the mask does not slip down when the user talks, glasses are prevented from being fogged by completely blocking gaps around the ridge of the nose when a user wears the mask, and both sides of the mask body come in close contact with the cheeks of a wearer. So the dental mask according to the present disclosure can be very useful.

1. A dental mask having an anti-flow and fogging function which has a rectangular mask body configured to cover the mouth and nose of a wearer and having a nose wire embedded in the upper end thereof, and ear bands attached to both sides of the mask body, respectively, to prevent the mask body from separating from a face when the mask is worn,
the dental mask is configured by attaching a nose ridge contact cover having a certain width to the lower part of the inner upper part of the mask body where the nose wire is embedded,
the nose ridge contact cover has both sides and top fused to the mask body, and the nose ridge contact cover is a dental mask having a dripping and anti-fogging function, characterized in that it is formed in two layers.

2. According to claim 1, the nose ridge contact cover is a dental mask having a dripping and anti-fog function, characterized in that the height in the vertical direction is ½ to ⅓ to of the height in the vertical direction of the mask body.

3. (canceled)

4. (canceled)
